(19) United States
(12) Patent Application Publication
(10) Pub. No.: US 2016/0307170 A1
(43) Pub. Date: Oct. 20, 2016

(54) APPARATUS AND METHOD FOR CONDUCTING AND MANAGING TRANSACTIONS BETWEEN DIFFERENT NETWORKS

(71) Applicant: BANK OF AMERICA CORPORATION, Charlotte, NC (US)

(72) Inventors: Scott Lee Harkey, Concord, NC (US); Matthew Laine Donlan, Charlotte, NC (US)

(21) Appl. No.: 14/686,283

(22) Filed: Apr. 14, 2015

(51) Int. Cl. G06Q 20/02; G06Q 50/00; G06Q 20/38

(52) U.S. Cl. CPC G06Q 20/027; G06Q 20/385; G06Q 50/01

(57) ABSTRACT

Embodiments of the invention include systems and methods for creating a customized framework for allowing members of a first network to conduct transactions with members of a second network, where the two networks do not otherwise allow members to conduct transactions with one another. The system may (i) communicate with the first network to receive transaction instructions from a party to the transaction, as well as the alias of the counterparty, (ii) communicate with the second network to receive aliases and transaction data associated with its members, and (iii) generate a directory that associated the members' aliases with the transaction data. The system performs the transaction based on the directory, the transaction instructions, the alias, and the transaction data. The system is also configured to allow a member of one network manage the third party networks that store and use information related to the member.

### BACKGROUND

Over recent years, products and services and being provided over multiple networks that are associated with distinct third parties.

For instance, many individuals have and monitor profiles with several different social network sites. These social networking sites allow for communication between members, receiving offers for products, viewing advertisements, playing games, and the like. However, social networks do not allow members to directly conduct transactions with members of different networks.

Additionally, payment networks have also been growing in popularity. These payment networks enable members to make payments and conduct other transactions with other members of the same payment network. However they do not enable members to make payments or conduct other transactions with members of other networks.

Lastly, retailers and other businesses each utilize and manage their own type of networks. These networks are typically computing networks that make websites or other platforms available for the purchase of goods and services. However, it is often difficult to conduct transactions with retailers and businesses without first registering as a member of their network. Further, if you are a member of a different network (i.e., a social network or a payment network), you cannot use that network to directly conduct transactions with the retailer or business.

Further, while conducting transaction within these various networks, members generally have to store payment and other financial information on each network for future use. As the number of networks used by any individual increases, it becomes more and more difficult for the individual to remember which networks it uses and which financial information that it has stored on the network.

In light of the foregoing, there exists a need to enable members of distinct networks that are incapable of communicating directly with one another to conduct transactions.

Further, there exists a need to allow individuals to visualize, control, and manage the networks on which they have stored their financial information. Further, to the extent an individual uses financial information to conduct transactions on different networks, the financial institution associated with that financial information serves as an intermediary between the individual and the various networks. Thus, the financial institution is in a unique position to conduct and manage transaction between unrelated networks.

### BRIEF SUMMARY

Embodiments of the present invention address the above needs and/or achieve other advantages by providing apparatuses (e.g., a system and/or other devices) and methods for an apparatus for performing and managing transactions between different networks.

In some embodiments, the apparatus (i) receives transaction instructions from a user via a computing device associated with a first network, wherein the transaction instructions comprise a description of a transaction between the user and a counterparty and an alias of the counterparty; (ii) receives member information from a computing device associated with a second network that comprises aliases for members of the second network and transaction data associated with the members of the second network, wherein the transaction data associated with the members of the second network is not known to members of the first network; (iii) generates a directory of the members of the second network, wherein the directory links the aliases of the members of the second network to the transaction data associated with the members; (iv) determines the transaction data associated with the counterparty by looking up the alias of the counterparty in the directory of members of the second network; and (v) performs the transaction between the user and counterparty using the transaction instructions and the transaction data associated with the counterparty.

In some embodiments, the first network and second network are social networks and the alias of the counterparty is the counterparty's user's name for a social network.

In some embodiments, the transaction instructions include instructions to transfer a sum of money from the user to the counterparty.

In some embodiments, the transaction data associated with the members of the second network comprises account numbers for bank accounts that are accessible via a distributed computer network. In other embodiments, the transaction data associated with the members of the second network comprises account numbers for bank accounts that are managed by a third party. In some embodiments, the apparatus performs the transaction by transmitting the transaction instructions and transaction data in encrypted format to the third party.

In other embodiments of the invention, the apparatus (i) receives from one or more distributed computer networks an electronic indication that a user has stored financial information on the one or more distributed computer networks; (ii) generates a database of the one or more distributed computer networks on which the user has stored financial information; (iii) receives a request from a computing device associated with the user to generate a graphical depiction of each distributed network on which the financial information is stored; (iv) generates the graphical depiction of each distributed network on which the financial information is stored; and (v) transmits the graphical depiction of each distributed network on which the financial information is stored to the computing device associated with the user.

In some embodiments, the one or more distributed computer networks are managed by one or more retailers from which the user has made purchases.

In some embodiments, the graphical depiction of each distributed computing network illustrates the distributed network's relationship to a financial institution associated with the user.

In some embodiments, the apparatus (i) receives, via a computing device associated with the user, a request to delete the financial information from at least one of the distributed computer networks on which the financial information is stored; and (ii) transmits the request to the at least one of the distributed network on which the financial information is stored.

In some embodiments, the apparatus (i) receive, via a computing device associated with the user, updated financial information; and (ii) transmits the updated financial information to each distributed network on which the financial information is stored.

In some embodiments, the graphical depiction of each distributed computing network includes on one or more distributed computing networks that are managed by one or more retailers that have a banking relationship with the user's financial institution.

### BRIEF DESCRIPTION OF THE DRAWINGS

Having thus described embodiments of the invention in general terms, reference will now be made for the accompanying drawings, wherein:

FIG. 1 is a block diagram illustrating a system and environment configured for conducting transactions between different networks, in accordance with one embodiment of the present invention;

FIG. 2 is a block diagram illustrating a more detailed system and environment configured for conducting transactions between different networks, in accordance with one embodiment of the present invention;

FIG. 3 is a block diagram depicting a networked computing device, in accordance with embodiment of the present invention;

FIG. 4 is a block diagram depicting a transaction apparatus, in accordance with one embodiment of the present invention;

FIG. 5 is a flow diagram depicting a process for conducting a transaction between different networks, in accordance with one embodiment of the invention;

FIG. 6 is a block diagram illustrating a graphical depiction of certain computer networks, in accordance with one embodiment of the present invention; and

FIG. 7 is flow diagram depicting a process for managing financial information across different computer networks, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments, of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise.

As defined herein, the term “transaction” means any type of transaction between two or more parties. In some embodiments the transaction is a financial transaction that is typical of a financial account, which may include but in not limited to a deposit, a withdrawal, a transfer from an account or into an account, the payment of fees associated with an account, the use of a debit, credit or other payment card, the purchase of goods or services or the payment for goods or services. As defined herein, a “financial account” may refer to, but is not limited to, a checking account, a savings account, an investment account (e.g. IRA, 401K), a certificate of deposit, a retirement account, a health savings account, an education account, a debit account, a credit account, and the like.

As used herein, the term “financial information” means any information relating to a financial account, such as a bank account number, a checking account number, a credit or debit card number, a wire transfer number or a routing number.

As used herein, the term “network” means any group or system of interconnected things. In some embodiments, the network may be a network of people, such as the members of a social network. In other embodiments, the network may be a group of individuals that are associated with a business, organization or other entity. In other embodiments, a network may be a group of individuals that receive or provide the same type of services. In still other embodiments, the term “network” refers to a computer network of two or more connected computing devices. Such a computer network may be formed over any type of network connection, which may include a local area network (LAN), a wide area network (WAN), a short range communication network (e.g. Bluetooth, Near Field Communication), or the Internet. In some embodiments the computer network is a public network, in which computing devices outside the network can communicate with computing devices inside the network. However, in other embodiments, the network may be a private network in which computers outside of the network may not see the computers within the network or directly communicate with them.

As defined herein, the term “social network” means any website, program, application, or the like that is a social structure of individual (or entities) that are connected by one or more specific types of interdependencies, such as friendships, kinships, common interests, financial exchanges, dislikes, or the like.

As defined herein, an “application” is a program executed by a computing device that receives a request and delivers a response based on the request. In some instances, the application may additionally submit requests and receive responses. An application may be based on a web protocol where it communicates using web technologies. The web application may be based on a RESTful protocol, which is a web service with a collection of resources including a base URI for the web service, a media type of data supported by the web service, a set of operations supported by the web service, and an API that is hypertext drive.

As defined herein, the term “alias” shall refer to a piece of information which may be used to identify another object or piece of information. Typically, in social networks and social web applications, a user is given a username to identify the user. Using the username, the user may interact with the social network and receive messages from the social network. An alias might include, but is not limited to, a username, a password, a phone number, an email address, and the like. In some instances, the alias might be limited in use (e.g. time limit, amount of times it may be used). Particularly, in some instances, an alias may be used one time before it expires. In other types of networks, an alias may be used to identify each member of the network.

Some portions of this disclosure are written in terms of a financial institution's unique position with respect to financial accounts and devices. In particular, a financial institution may have relationships with different entities and individuals, such as consumer banking relationships, payment processor relationships, business banking relationships, and investment advisor relationships. Due to these relationships, a financial institution serves a “connector” between individuals and entities that are otherwise not related. As such, as described in greater detail herein, the financial institution may be able to leverage its unique position as a “connector” to (i) process transactions between two unrelated parties and (ii) manage information about its customers' accounts.

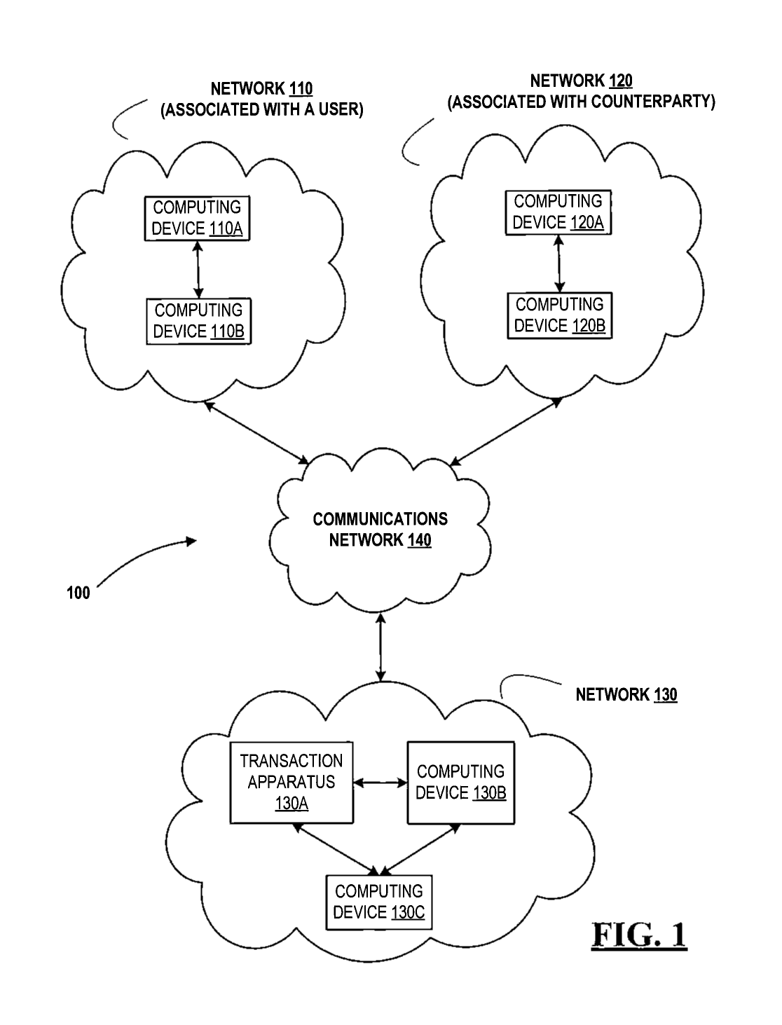

FIG. 1 provides a block diagram illustrating a system and environment 100 for completing a financial transaction between a user and a counterparty, in accordance with one embodiment of the present invention. The environment depicts multiple networks 110 and 120, wherein network 110 comprises computing devices 110A and 110B and network 120 comprises computing devices 120A, and 120B. Each computing device within its respective network is capable of communicating with other computing devices within the same network. In one embodiment, the networks 110 and 120 are each social networks and the computers are capable of communicating with each other through the social network. Specifically, each computing device within a network may be configured to communicate with a web server that executes a web application. The web application enables the computing devices 110A, 110B, 120A, and 120B to communicate with each other in the respective networks 110 and 120. In other embodiments, network 110 and/or network 120 may be operated by merchants, retailers, service providers, financial institutions or other individuals or entities that provide goods or services. In such embodiments, with respect to network 110 and network 120, the computing devices that make up each network (i.e., computing devices 110A, 110B, 120A, and 120B) perform functions relating to the business of the merchant, retailer, service provider, financial institution or other individuals or entities that provide goods or services, such as hosting a website, payment processing, and/or the storage of customer databases. While not depicted in FIG. 1, network 110 and network 120 may contain more computing devices than just computing devices 110A, 110B, 120A, and 120B.

FIG. 1 depicts one embodiment of the invention in which network 110 and network 120 are both private networks. Accordingly, computing devices 110A and 110B are not visible to computing devices 120A and 120B (and vice versa). Additionally, computing devices 110A and 110B cannot directly communicate or conduct transactions with computing devices 120A and 120B (and vice versa).

In one embodiment, network 110 is associated with a user of the transaction apparatus of the present invention (hereinafter referred to as, “user”) who wishes to complete a transaction with a counterparty that is associated with network 120. As described in more detail herein, the user is unable to conduct transactions directly with the counterparty. In some embodiments, this may be because the user does not have access to all of the information about the counterparty that would enable the user to complete the transaction.

In other embodiments, the user cannot complete a transaction with the counterparty because networks 110 and 120 limit communication with computing devices outside of the networks based on hardware or software restrictions. In other words, network 110 restricts computing devices 110A, 110B from receiving communications from computing devices 120A and 120B, and network 120 restricts computing devices 120A and 120B from receiving communications from computing devices 110A and 110B. This may be accomplished using a LAN or similar type of network structure.

FIG. 1 also depicts network 130, which is computer network comprised of various computing devices, including transaction apparatus 130A, as well as computing devices 130B and 130C. In some embodiments of the invention, network 130 is managed by a financial institution. Transaction apparatus 130A is a computing device configured to process transactions in accordance with the present invention. Further, computing devices 130B and 130C are computing devices that are configured to communicate with transaction apparatus 130A over network 130. In the embodiment of the invention where network 130 is managed by a financial institution, computer devices 130B and 130C may store data related to the financial institution, such as account data, or perform other functions related to the operation of the financial institution.

FIG. 1 also illustrates communications network 140, which is the network through which network 110 and network 120 are capable of communicating directly with network 130. Communications network 140 may include a local area network (LAN), a wide area network (WAN), a global area network (GAN), near field communication network, infrared network, Bluetooth network or any other type of communications network or protocol. In some embodiments, communications network 140 may comprise the Internet. In addition, communications network 140 may include first, second, third, and/or fourth-generation cellular communication networks and/or the like. For example, communications network 140 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The communications network 140 may provide for wired, wireless, or a combination of wired and wireless communication between devices on the network.

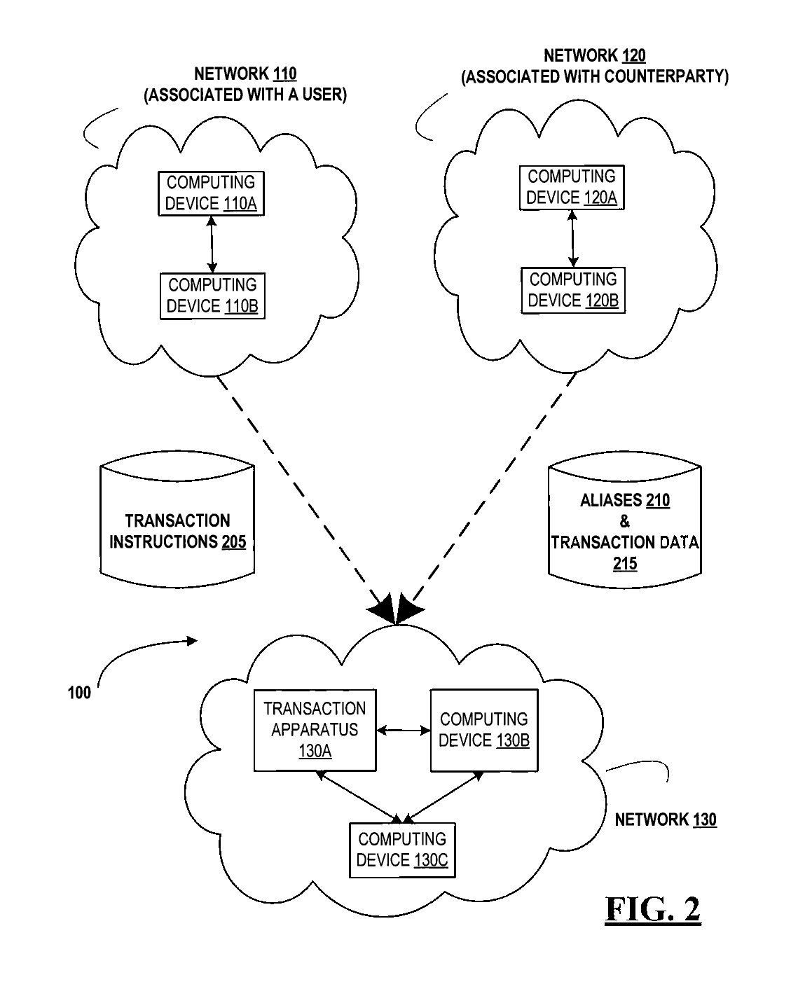

Now referring to FIG. 2, a more detailed block diagram illustrating a system and environment 100 for completing a financial transaction between a user and counterparty is provided. In particular, FIG. 2 illustrates the same system and environment 100 as FIG. 1, except that it also depicts the flow of information and data from network 110 and network 120 to network 130 in connection with the present invention. Although not depicted in FIG. 2, network 110 and network 120 transmit information and data to network 130 via communications network 140.

As depicted in FIG. 2, as part of the present invention, network 110 transmits to transaction apparatus 130A on network 130 the following data: transaction instructions 205. The transaction instructions 205 include information related to a transaction that the user associated with network 110 wants to engage in with a counterparty associated with network 120. In some embodiments, the transaction instructions 205 include a description of the transaction between the user and the counterparty, such as a description of a financial transaction or the user's financial account involved in the transaction. Additionally, in some embodiments, the transaction instructions 205 also include an alias of the counterparty, such as the alias that the counterparty uses in connection with network 120. For example, in an embodiment of the present invention where network 110 and network 120 are social networks, the transaction instructions 205 could comprise (i) a description of an amount of money to transfer from the user to the counterparty; (ii) the user's financial account from which it wants to transfer the money; and (iii) the alas, or social network user name that is used by the counterparty on network 120.

As depicted in FIG. 2, network 120 may transmit aliases 210 and transaction data 215 to transaction apparatus 130A on network 130. In some embodiments, aliases 210 comprise the aliases for all of the members of network 120. For instance, in embodiments of the invention where network 120 is a social network, aliases 210 may comprise all of the user names of the members of the social network. Additionally, in some embodiments of the invention, network 120 may transmit transaction data 215 to transaction apparatus 130A on network 130. Transaction data 215 may comprise any information about the members of network 120, but it some embodiments it may comprise financial information or other information about the financial accounts of the members of network 120 (e.g., bank account numbers, credit card numbers, checking account numbers, savings account numbers, routing numbers, wire transfer numbers, etc.). In some embodiments, network 120 has access to transaction data 215 because the members of network 120 stored such transaction data 215 on the network. For instance, if network 120 is a social network, then the members of network 120 may have added the transaction data 215 to their social network profiles. Alternatively, if network 120 is a computer network managed by a retailer, members of network 120 (i.e., people who have purchased goods from the retailer) may have stored their transaction data 215 on network 120 when they purchased goods from the retailer.

In some embodiments of the invention, network 110 may transmit the transaction instructions 205 to transaction apparatus 130A in encrypted format. Further, in some embodiments of the invention, network 120 may transmit the aliases 210 and transaction data 215 to transaction apparatus 130A in encrypted format.

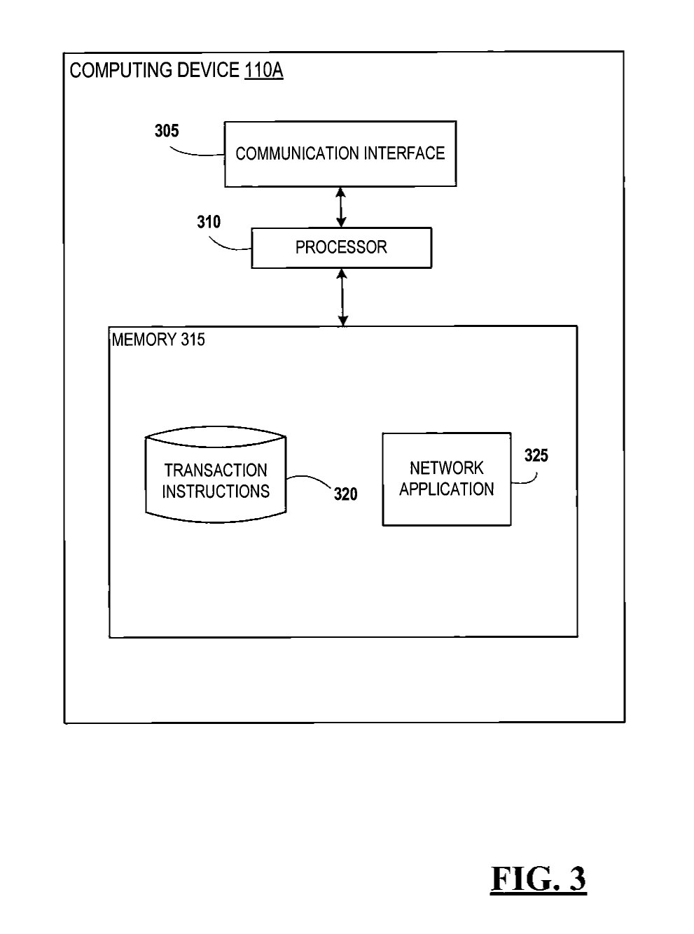

Referring to FIG. 3, a computing device 110A is described in further detail. It should be noted that the computing device 110A described in FIG. 3 is one embodiment of a computing device that is typically used. The computing device 110A may further refer to a mobile device, a tablet, a personal computer, an MP3 player, and the like. The computing device 110A comprises a communication interface 305, a memory 315, and a processor 310 that is operatively coupled to the communication device 305 and the memory 315.

The communication interface 305 enables the computing device 110A to connect to a network. Such network connection might either be wired or wireless. Using the communication interface 305, the computing device 110A might be configured to communicate with the other computing devices on network 110 or another respective network. Specifically, in some embodiments, the communication interface 305 is capable of communicating with a given protocol stack with a web application hosted on the network 110.

The memory contains at least a network application 325 and a data store for transaction instructions 320. For clarification, transaction instructions 320 may be the same as transaction instructions 205 that are discussed in connection with FIG. 2. In some embodiments, the network application 325 enables the computing device 110A to communicate with the web application of the network 110. The network application 325 may be a web browser that interprets code received from the web application. Such code may be represented as Hyper Text Markup Language (HTML), Javascript, Cascading Style Sheets (CSS), Extensible Markup Language (XML), and the like. Additionally, the web browser may contain additional plugins to enhance the user experience while interacting with the web application. In other embodiments, the network application 325 is a custom designed application that is executed by the computing device 110A. Such application may be executed directly by the computing device 110A or by use of an interpreter such as a scripting engine. The network application 325 may be configured to interact with a web application by communicating requests to the web application, as defined herein.

Although not depicted in any figure, computer device 120A (as depicted in FIGS. 1 and 2) is of a similar structure as computing device 110A, except that the memory of computing device 120A may store aliases 210 and transaction data 215.

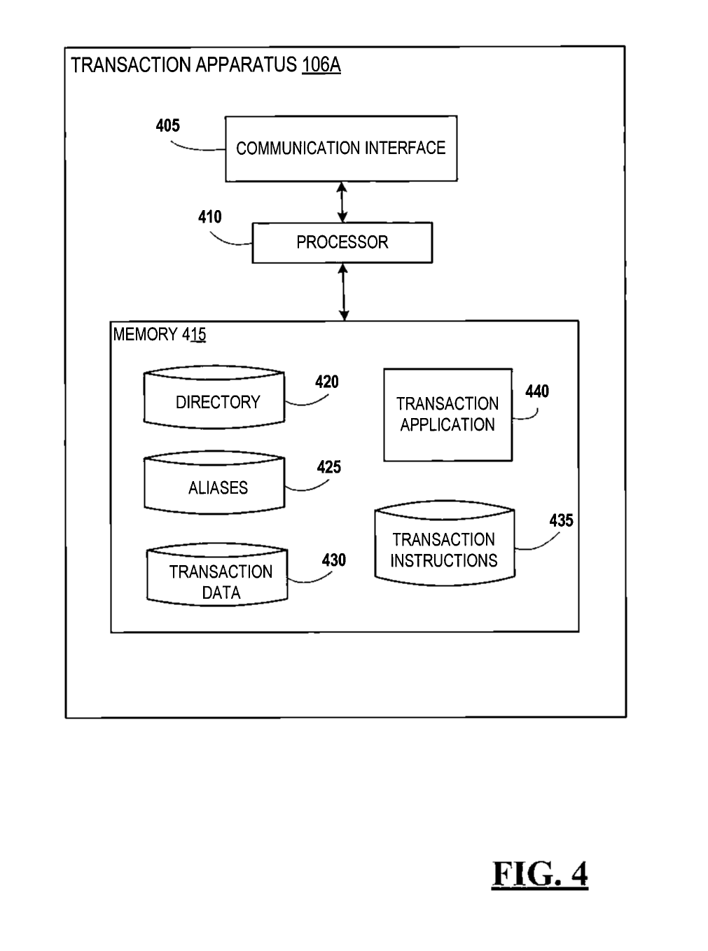

Referring to FIG. 4, a transaction apparatus 130A is presented in accordance with various embodiments of the present invention. The transaction apparatus is part of a network 130. The transaction apparatus 130A contains at least a communication interface 405 that is used to connect the transaction apparatus to the network 130, a memory 415, and a processor 410 that is operatively coupled to the communication interface 405 and the memory 415. In some embodiments, the communication interface 405 further enables the transaction apparatus 130A to communicate with devices outside of the network 130.

The memory 415 of the transaction apparatus 130A contains storage modules and code which is executable by the processor. With respect to the storage modules, the memory 415 of the transaction apparatus 130A contains a directory 420, aliases 425, transaction data 430, and transaction instructions 435. With respect to the executable code, the memory 415 contains a transaction application 440 which is executable by the processor 410.

In some embodiments, the transaction application 440 causes the processor 410 to communicate with network 110 to receive transaction instructions 205 and to store transaction instructions 205 as transactions instructions 435 in memory 415. Further, in some embodiments, the transaction application 440 causes the processor 410 to communicate with network 120 to receive aliases 210 and transaction data 215 and to store them in memory 415 as aliases 425 and transaction data 430, respectively.

In some embodiments of the invention, directory 420 is a database that associates aliases 425 with related transaction data 430. In some embodiments, where a member of network 120 is both the subject of an alias 425 and transaction data 430, the processor 410 will create a directory 420 entry that associates the appropriate alias of aliases 425 of that member with the related transaction data 430. After performing the association between the aliases 425 and the transaction data 430, the transaction application 440 instructs the processor 410 to store the associated information in the directory 420 in memory 415. For example, in some embodiments of the invention, where network 120 is a social network, aliases 425 are the aliases of the members of the network, and the transaction data 430 is bank account numbers. Further, in such embodiment, directory 430 may associate the aliases 425 of the members of the social network with their respective bank account numbers. In other embodiments, directory 420 associates any type of alias for a network member with any type of transaction data for that member.

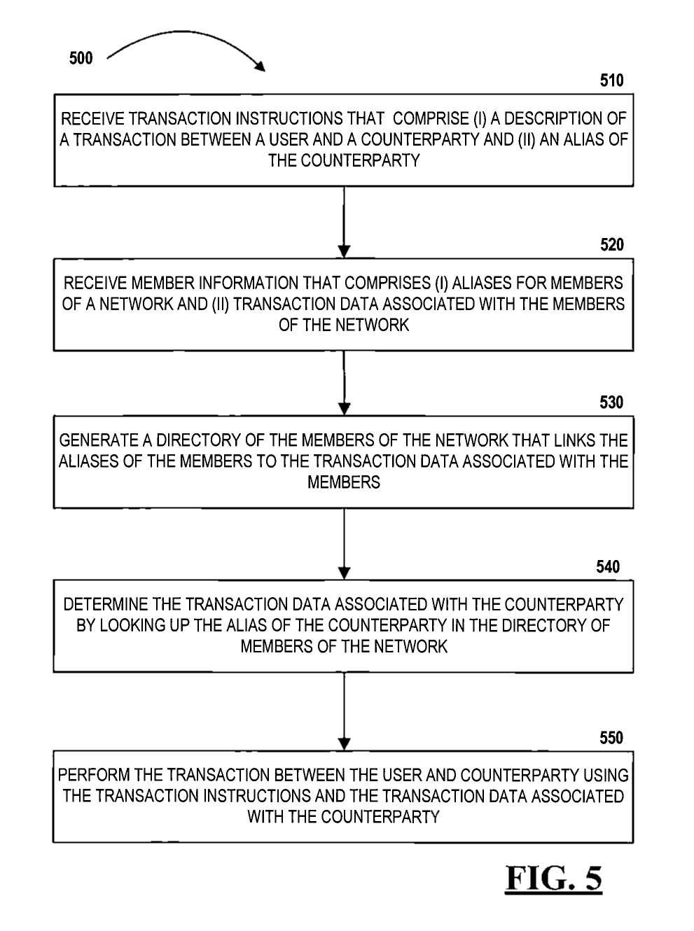

FIG. 5 presents a method 500 for enabling a user to conduct a financial transaction with a counterparty in another network, in accordance with one embodiment of the invention. In this embodiment of the invention, the user is a member of one network, such as network 110, and the counterparty is the member of another network, such as network 120. Network 120 is a social network. As discussed in connection with FIG. 1 and FIG. 2, the user and counterparty are unable to directly perform transactions with one another because network 110 is incapable of communicating directly with network 120.

At Block 510, transaction apparatus 130A receives from network 110 transaction instructions that comprise: (i) a description of a transaction between a user and a counterparty; and (ii) an alias of the counterparty. In some embodiments, a user, using a computing device 110A, may communicate a request to perform a transaction involving a financial account of the user. In this embodiment, the alias of the counterparty comprises a social network alias and the transaction comprises transferring an amount of money from the user to the counterparty. Since the user does not know the bank account number of the counterparty, the user can only include the counterparty's social network alias within the transaction instructions.

In some embodiments of the invention, the transaction instructions may contain additional information for how the transaction should be processed. In some embodiments, the user may select a rate at which the counterparty may receive the funds from the transaction. For example, the user may request to pay to the counterparty $100.00 at a rate of $10.00 every week until the funds are paid in full. Therefore, the transaction could only transfer up to $10.00 per week. Additionally, in some embodiments, the user may select a date on which the counterparty will receive the transfer of funds. For example, the user may state that the counterparty will receive $100.00 at a specified date in the future. In some embodiments, the user may specify a range of amounts to transfer to the counterparty (i.e., between $50 and $200) and the counterparty may detail the exact amount of money that the counterparty would like to have transferred. While the following different embodiments of transaction instructions have been discussed in the context of the transfer of money from the user to the counterparty, they could be equally applicable to any other type of transactions.

At Block 520, transaction apparatus receives member information that comprises: (i) aliases for the members of private network 120; and (ii) transaction data associated with the members of network 120. In this embodiment of the invention, the aliases for the members of network 120 comprise social network aliases and the transaction data comprises the bank account numbers of the members of network 120. Additionally, in this embodiment of the invention, transaction apparatus 130A identifies that the alias that it received at Block 510 is associated with network 120 and that is why it requests that network 120 to transmit to it a list of all member aliases and associated transaction data. In other embodiments of the invention, transaction apparatus 130A may have already received all of the member aliases and transaction data at an earlier point in time. While in this embodiment of the invention, the member aliases and transaction data are received directly from network 120, in other embodiments of the invention, all or a portion of the aliases and transaction data may be received from one or more third parties that are not necessarily the network that is associated with the member aliases and transaction data.

At Block 530 the transaction apparatus generates a directory of the members of network 120 and the directory links the aliases of the members to the transaction data associated with the members. In this embodiment of the invention, the directory links the social network aliases of the members of network 120 with their bank account information. However, in other embodiments of the invention, each alias may be linked to one or more pieces of transaction data associated with the alias. Transaction apparatus 130A can use this directory to identify certain transaction data that is associated to any particular alias. In other words, given a specific alias, transaction apparatus 130A can look up the alias in the member directory to identify related transaction information. Thus, even if a user does not know certain transaction data relating to a counterparty to a transaction, transaction apparatus 130A can determine the transaction data by accessing the directory of members.

At Block 540, transaction apparatus 130A determines the transaction data associated with the counterparty by looking up the alias of the counterparty in the directory of members of the network. In this embodiment of the invention, using the alias from the transaction instructions (see Block 510), the transaction apparatus 130A searches the directory (i.e., directory 420 from FIG. 4) to find an appropriate financial account for completing the transaction. In some embodiments, where transaction apparatus 130A is unable to associate a financial account or other transaction data with the alias (or where the alias is not included in the directory), the transaction apparatus 130A may communicate a message to the counterparty using the alias received at Block 510 to notify the counterparty that the user wishes to conduct a transaction with the counterparty. In other embodiments, transaction apparatus 130A may communicate a message to the user indicating the counterparty's alias is not known to transaction apparatus 130A. In some embodiments, the directory may list multiple financial accounts associated with an alias, and thus the transaction apparatus 130A may identify multiple financial accounts of a counterparty. In such an instance, transaction apparatus 130A may communicate a message to the counterparty using the alias requesting that the counterparty select a specific financial account for use in the transaction or supply information related to a preferred financial account.

At Block 550, the transaction apparatus 130A performs the transaction between the user and the counterparty using the transaction instructions and the transaction data associated with the counterparty. In this embodiment, transaction apparatus transfers money from the user to the financial account associated with the counterparty, where transaction apparatus 130A identified the financial account by searching the alias of the counterparty in the directory of members of network 120. In this embodiment, transaction apparatus 130A is operated by a financial institution that manages the financial accounts of both the user and the counterparty. Thus, in this embodiment, the financial institution transfers the money from the user's account to the counterparty's account. However, in some other embodiments of the invention, where the user's account and/or the counterparty's account are managed by a third party, transaction apparatus 130A may perform the transaction by transmitting the transaction instructions, alias of the counterparty, and/or transaction data associated with the counterparty to the parties in order to finalize and effectuate the transaction. Although not disclosed at Block 550, in some embodiments, the transaction apparatus 130A may communicate a message to the user and/or counterparty that the transaction was successful.

FIG. 5 described a process flow of one embodiment of the invention in which a user transfers money from its financial account to the account of the counterparty. However, the same process flow would equally apply to other types of transactions, including without limitation, a user's payment of goods and services using a credit card or debit card or the withdrawal by a user from an account associated with a counterparty.

As described herein, a financial institution is uniquely positioned to manage information about its customers' accounts due to its many relationships with third parties. For example, a financial institution may manage a customer's financial account (e.g., savings account or checking account) and/or issue a credit or debit card to a customer. The customer may use these financial accounts or cards to purchase goods and/or services from third parties. In many instances, the customer may purchase goods and/or services from third parties via a website, mobile application, electronic kiosk or other electronic means and may have the opportunity to store banking information with the third party for future use. For instance, when a user makes a purchase via a third party website, the user may store its financial information on a computer network managed by the third party. In such instances, the third party may provide an indication to the customer's financial institution that the customer has stored financial information with the third party. Thus, the financial institution serves a “connector” between its customers and the third parties with which they enter into transactions.

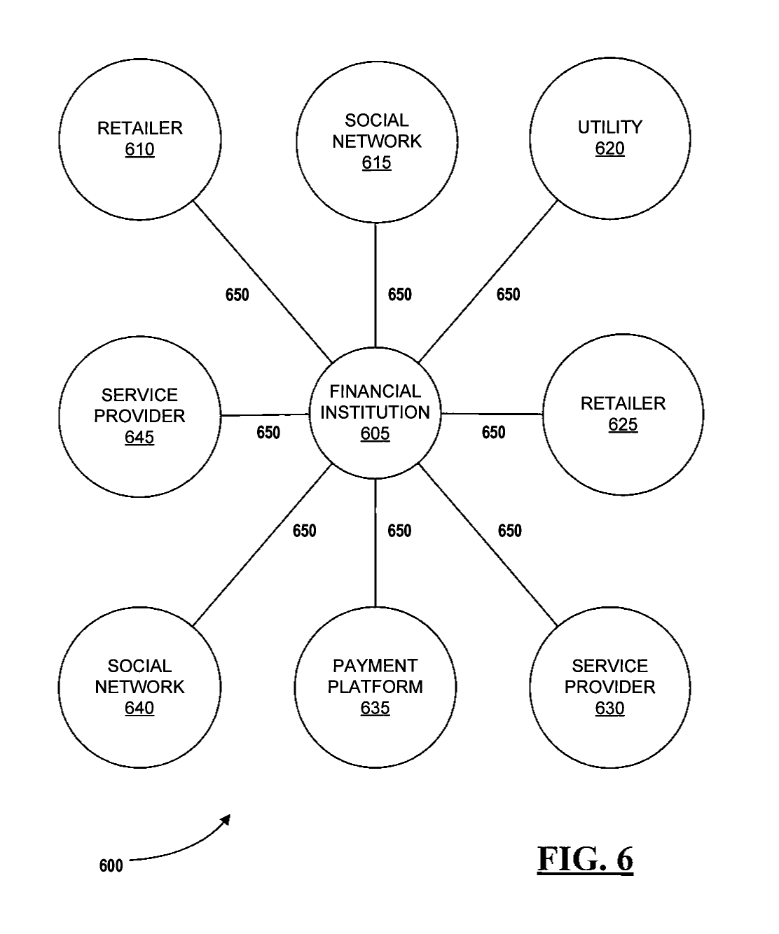

Referring now to FIG. 6, a block diagram is presented that illustrates a graphical depiction of a financial institution's relationships to third party computer networks on which a customer of the financial institution has stored financial information. As described in greater detail herein, this graphical depiction illustrates the financial institution's role connecting its customer to various third parties. Financial Institution 605 is an icon that represents the customer's financial institution. Retailer 610 and Retailer 625 are icons the represents retailers that manage computer networks on which the customer's financial information is stored. In one embodiment, the customer stores its financial information on the retailers' computer networks when it completes transactions with the retailers. Social Network 615 and Social Network 645 are icons that represent social networks that manage computer networks on which the customer's financial information is stored. In one embodiment, the customer stores its financial information on the social networks' computer networks as part of completing a social network profile. Utility 620 is an icon that represents a utility that manages a computer network on which the customer's financial information is stored. In one embodiment, the customer stores its financial information on the utility's computer network when it signs up for automatic payment of its utility bills. Service Provider 630 and Service Provider 645 are icons that represent service providers that manage computer networks on which the customer's financial information is stored. In one embodiment, the customer stores its financial information on the service providers' computer networks when it purchases services from the service providers. Payment Platform 630 is an electronic third party payment platform that manages a computer network on which the customer's financial information is stored. In one embodiment, the customer stores its financial information on the payment platform's computer network when it registers to participate in the payment platform. It should be understood that FIG. 6 represents just one embodiment of a graphical depiction of a financial institution's relationships to third party computer networks on which a customer of the financial institution has stored financial information. In other embodiments, the graphical depiction may include any number of icons that represent any other types of third party computer networks on which the financial institution customer has stored its financial information.

As depicted in FIG. 1 and FIG. 2, transaction apparatus 130A is configured to communicate with one or more third party networks. In some embodiments, transaction apparatus 130A may also be configured to generate the graphical depiction of FIG. 6 and transmit it to a computer device associated with the financial institution's customer. In some embodiments, a financial institution's customer may submit a request to see the graphical depiction of FIG. 6 via an online banking application or a mobile application. Upon receiving this request, transaction apparatus 130A may generate and transmit the graphical depiction to the customer, where it is accessible via the customer's computing device (i.e., computer, mobile phone, tablet, etc.).

Referring back to FIG. 6, each of Retailer 610, Social Network 615, Utility 620, Retailer 625, Service Provider 630, Payment Platform 635, Social Network 640, and Service Provider 645 are connected to Financial Institution 605 via a connection 650. Each of connections 650 represents the fact that the customer of Financial Institution 605 is connected to each of these third party computer networks through the storage of its financial information. Each of connections 650 (or, in other embodiments, other portions of FIG. 6) are selectable by the customer (via the customer's computing device) and selecting each of connections 650 (or other interactive portion) activates certain functionality. In one embodiment, selecting the connection 650 between Financial Institution 605 and an icon representing a third party computer network enables the customer to view, delete, edit and/or stop using the financial information that it stored on the third party computer network. For instance, by selecting the connection 650 between Financial Institution 605 and Retailer 605, the customer can view, delete, and/or edit the financial information that is stored on the computer network managed by the retailer or indicate to the retailer that it should stop using the financial information.

In other embodiments, selecting the connection 650 between Financial Institution 605 and an icon representing a third party computer network enables the customer to add preferences for when the third party uses the customer's financial information. For instance, by selecting the connection 650 between Financial Institution 605 and Retailer 605, the customer can indicate that it only wants to the retailer to use the customer's stored financial information for purchases that exceed (or fall below) a certain threshold amount.

In yet other embodiments, selecting the connection 650 between Financial Institution 605 and an icon representing a third party computer network enables the customer to view information about how the third party uses its financial information. For instance, by selecting the connection 650 between Financial Institution 605 and Retailer 605, the customer can view recent transactions with the retailer, the dates and amounts of those transactions, and/or other statistics relating to the customer's transactions with the retailer, such as the categories of such transactions (e.g., food, entertainment, etc.), whether the transactions are one-time or recurring transactions, or whether the transactions were made via a website, mobile device or other apparatus.

In yet another embodiment, selecting the connection 650 between Financial Institution 605 and an icon representing a third party computer network enables the customer to request that a third party get preapproval from the customer prior to any future transactions using the stored financial information. For instance, by selecting the connection 650 between Financial Institution 605 and Retailer 605, the customer can request that the retailer first obtain the customer's prior approval before user the stored financial information for any future transactions. In some embodiments, the request for prior approval could be transmitted to the customer's computing device via transaction apparatus 130A.

To the extent necessary to implement any of the functionality described herein, transaction apparatus 130A is configured to communicate with each of the third parties that manages a computer network on which the customer has stored financial information.

As set forth above, the graphical depiction of a financial institution's relationships to third party computer networks set forth in FIG. 6 provides a unique and convenient way for a financial institution's customer to identify and manage the third party computer networks on which its financial information is stored. Instead of having to remember each third party with which it has stored its financial information and managing that information on an individual basis (e.g., visiting each website on which it has stored financial information), the functionality of the graphical depiction of FIG. 6 allows the customer to manage its financial information via one location. Further, the graphical depiction of a financial institution's relationships to third party computer networks set forth in FIG. 6 illustrates how the customer's financial institution services as a “connector” to all of the third parties with which the customer conducts transactions.

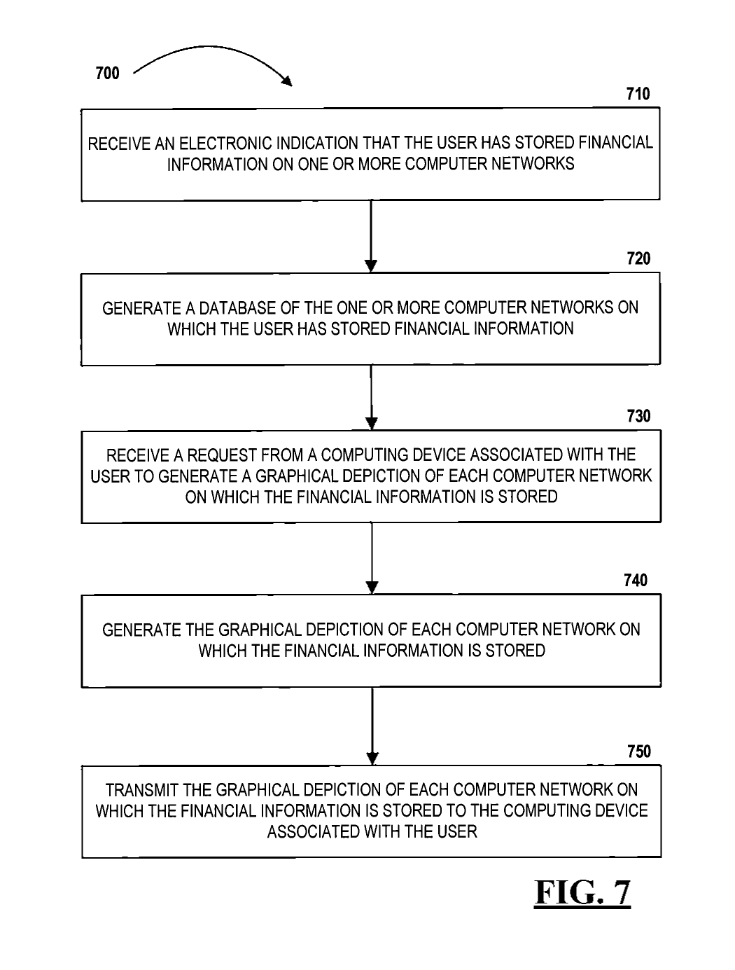

FIG. 7 presents a method 700 for generating the graphical depiction of a financial institution's relationships to third party computer networks (as described in FIG. 6). In this embodiment of FIG. 7, the user is a customer of the financial institution and method 700 is carried out by transaction apparatus 130A. At the first step of method 700, depicted in Block 710, the financial institution receives one or more electronic indications that the user has stored financial information on one or more computer networks. In one embodiment, the user performs financial transactions with one or more merchants and in the course of finalizing the transactions with the one or more merchants, the user provides the merchant with financial information. The financial information may include payment card information, an alias, and the like. In this embodiment, the merchants using the financial information notify the financial institution associated with the user that the user has stored financial information on computer networks managed by the merchants. In some embodiments, transaction apparatus 130A may receive these notifications.

At Block 720, transaction apparatus 130A generates a database of the one or more computer networks on which the user has stored its financial information. This database may be stored in the memory of transaction apparatus 130A or it may be stored on a separate computing device with which transaction apparatus 130A communicates.

At Block 730, after the transaction apparatus 130A stores the database, the transaction apparatus may receive a request from a computing device associated with the user to generate a graphical depiction of each distributed network on which the financial information is stored, as is explained in block 730.

Block 730, transaction apparatus 130A receives a request from the user to generate a graphical depiction of each computer network on which the user's financial information is stored. In one embodiment, the user submits this request via a financial institutions online banking platform. However, in other embodiments, the user could submit the request via a mobile application or other electronic means.

At Block 740, transaction apparatus 130A generates the graphical depiction of each computer network on which the user's financial information is stored. One embodiment of such graphical depiction is described in greater detail in connection with FIG. 6.

Block 750 presents transmitting the graphical depiction of each distributed network on which the financial information is stored to the computing device associated with the user.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will be understood that one type of computing network of the present invention is a private network in which a first computing device is located on a LAN that communicates with the Internet. A server may be connected to the Internet that hosts a web application that receives requests over the Internet and communicates responses to the requests. The computing device may communicate a request to the web server in order to interact with the web application. As a response, the web server communicates a response back to the computing device even though it is inside of the LAN. Particularly, the web server may act as an intermediary between multiple computing devices that would otherwise be unable to communicate with one another because of networking restrictions. Typically, a LAN that is connected to the Internet is assigned an Internet Protocol (IP) address to receive messages over the Internet. For all computing devices located on the LAN, the LAN supplies a local IP address for each of those computing devices. Without proper configuration, the local IP address is hidden to devices outside of the LAN. Therefore, a device outside of the LAN may not send a request directly to a computing device within the LAN. However, the device within the LAN may communicate a request to a device outside of the LAN using the IP address of the LAN. The LAN may track the request and the device that submitted the request. When the computing device outside of the LAN receives the request and submits a response back, the response is sent to the LAN. Because the LAN tracked the computing device that submitted the request, the LAN forwards the response to the computing device within the LAN. Using hardware to setup the LAN, the LAN may be configured such that devices from outside the LAN may send requests to devices within the LAN. One method that may be used to allow a device outside a LAN to communicate with devices within the LAN is using address forwarding. Address forwarding is the process of forwarding a request based on a parameter of the request. Such parameters may include a designated port, a URL, a protocol used to submit the request, and the like. For example, computer A is located on a LAN. A router is used to establish the LAN and is configured to forward all requests that are received by the router using port 80 to computer A. Thus all requests that are received by the router for port 80 are forwarded to computer A.

Typically a socket has a life cycle which includes: request to connect, connection, operation request, response, and termination. The request to connect and connection may be performed by any protocol known between the end point devices. A request is usually received over a first port of the server (or receiving device). The server typically creates the connection by opening up a second port between the server and the client (or requesting device). Because the server receives requests on a known port (such as 80), when the server opens up a subsequent port, the server does not tie up the first port. This allows the server to receive multiple requests from different computing devices. For example, Computer A sends a request to communicate with a server using port 80. The server opens port 8000 to further receive requests from Computer A. Computer B sends a request to communicate with the server using port 80 and the server opens port 8001 to further receive requests from Computer B. The initial connection request may be performed using a forwarding request, as explained earlier.

After a connection has been established between the client and the server, the two computing devices are able to communicate freely with one another. In some instances, a simple request and response may be the only thing that occurs prior to termination. However, in some instances, a complex exchange of information may take place where multiple requests and response are supplied.

Communication ceases when termination occurs. Termination may occur as a result of an expected termination or an unexpected termination. With respect to the expected termination, the client and/or the server may terminate the channel by closing the port upon which the channel was open. With respect to the unexpected termination, the client or the server doesn't close the channel but somewhere along the communication path an error occurs. For example, a router that is used to forward packets between the endpoint devices suffers an error and is unable to properly forward the packets.

In accordance with some embodiments of the present invention, a web application may secure information based on some type of authentication. Such authentication may be any type of information that identifies either a computing device upon which a request is sent or a user of such computing device. Typical authentication methods include a username and password, or a shared key. The web application may answer requests based on the authentication credentials. Additionally, the server may use other methods for tracking information of the client computing device such as a cookie or a session variable. A cookie is stored on the client computing device and is accessible by the server. The server may be able to both read and write to the cookie. A session variable is a special type of cookie that identifies a particular conversation between the client and the server. The server may associate particular data associated with the session variable and store such data on the server. As the server reads the session variable it may send the stored information associated with the session variable to the client. Session variables are an important means of protecting data. To add additional layers of security, the server may update the session variable after every response so that the subsequent request must contain the updated session variable. Thus, if an old session variable is discovered by another computer, it cannot use that session variable to access information. The server may also set a time limit for receiving a session variable to make a request. If the request is not received prior to the expiration of the time limit, the server may refuse to honor the request.

Where the web application requires specific authentication credentials, after receiving such credentials, the web application may serve specific requests from the client. While the web application may be configured to perform any amount of functionality within the limitations of the particular software and hardware of the device upon which the web application is being executed, one particular function of the web application might include being an intermediary between two separate clients, thus resulting in a pseudo-network bridge between the clients. Thus, a first client may communicate directly to a second client even though the clients may be located on separate LANs.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for performing a transaction between a user and a counterparty, wherein the user is a member of a first network and the counterparty is a member of a second network, the apparatus comprising:
a communication device that is configured to communicate with both the first network and the second network, wherein members of first network cannot perform transactions directly with members of the second network; and
a processing device communicably coupled to the communication device, wherein the processing device is configured to:
receive transaction instructions from the user via a computing device associated with the first network, wherein the transaction instructions comprise (i) a description of the transaction between the user and the counterparty and (ii) an alias of the counterparty;
receive member information from a computing device associated with the second network that comprises (i) aliases for members of the second network and (ii) transaction data associated with the members of the second network, wherein the transaction data associated with the members of the second network is not known to members of the first network;
generate a directory of the members of the second network, wherein the directory links the aliases of the members to the transaction data associated with the members;
determine the transaction data associated with the counterparty by looking up the alias of the counterparty in the directory of members of the second network;
perform the transaction between the user and counterparty using the transaction instructions and the transaction data associated with the counterparty.

2. The apparatus of claim 1, wherein the first network and second network are social networks.

3. The apparatus of claim 1, wherein the alias of the counterparty is the counterparty's user's name for a social network;

4. The apparatus of claim 1, wherein the transaction instructions include instructions to transfer a sum of money from the user to the counterparty.

5. The apparatus of claim 1, wherein the transaction data associated with the members comprises account numbers for bank accounts that are accessible via a distributed computer network;

6. The apparatus of claim 1, wherein the transaction data associated with the members comprises account numbers for bank accounts that are managed by a third party;

7. The apparatus of claim 6, wherein the processor is further configured to perform the transaction by transmitting the transaction instructions and transaction data in encrypted format to the third party.

8. A method for performing a transaction between a user and a counterparty, wherein the user is a member of a first network and the counterparty is a member of a second network, the method comprising:
receiving transaction instructions from the user via a computing device associated with the first network, wherein the transaction instructions comprise (i) a description of the transaction between the user and the counterparty and (ii) an alias of the counterparty and further wherein the user cannot directly perform the transaction with the counterparty;
receiving member information from a computing device associated with the second network that comprises (i) aliases for members of the second network and (ii) transaction data associated with the members of the second network, wherein the transaction data associated with the members of the second network is not known to members of the first network;
generating a directory of the members of the second network, wherein the directory links the aliases of the members to the transaction data associated with the members;
determining the transaction data associated with the counterparty by looking up the alias of the counterparty in the directory of members of the second network;
performing the transaction between the user and counterparty using the transaction instructions and the transaction data associated with the counterparty.

9. The method of claim 8, wherein the first network and second network are social networks.

10. The method of claim 8, wherein the alias of the counterparty is the counterparty's user's name for a social network;

11. The method of claim 8, wherein the transaction instructions include instructions to transfer a sum of money from the user to the counterparty.

12. The method of claim 8, wherein the transaction data associated with the members comprises account numbers for bank accounts that are accessible via a distributed computer network;

13. The method of claim 8, wherein the transaction data associated with the members comprises account numbers for bank accounts that are managed by a third party;

14. The method of claim 13, wherein performing the transaction further comprises transmitting the transaction instructions and transaction data in encrypted format to the third party.

15. An apparatus for managing a user's financial information across different distributed computer networks, the apparatus comprising:
a communication device; and
a processing device communicably coupled to the communication device, wherein the processing device is configured to:
receive from one or more distributed computer networks an electronic indication that the user has stored financial information on the one or more distributed computer networks;
generate a database of the one or more distributed computer networks on which the user has stored financial information;
receive a request from a computing device associated with the user to generate a graphical depiction of each distributed network on which the financial information is stored;
generate the graphical depiction of each distributed network on which the financial information is stored; and
transmit the graphical depiction of each distributed network on which the financial information is stored to the computing device associated with the user.

16. The apparatus of claim 15, wherein the one or more distributed computer networks are managed by one or more retailers from which the user has made purchases.

17. The apparatus of claim 15, wherein the graphical depiction of each distributed computing network illustrates the distributed network's relationship to a financial institution associated with the user.

18. The apparatus of claim 15, wherein the processor is further configured to:
receive, via the computing device associated with the user, a request to delete the financial information from at least one of the distributed computer networks on which the financial information is stored; and
transmit the request to the at least one of the distributed network on which the financial information is stored.

19. The apparatus of claim 15, wherein the processor is further configured to:
receive, via the computing device associated with the user, updated financial information; and
transmit the updated financial information to each distributed network on which the financial information is stored.

20. The apparatus of claim 16, wherein the graphical depiction of each distributed computing network includes one or more distributed computing networks that are managed by one or more retailers that have a banking relationship with the user's financial institution.
